(19) United States
(12) Patent Application Publication
(10) Pub. No.: US 2018/0194248 A1
(43) Pub. Date: Jul. 12, 2018

(54) LONGITUDINAL ADJUSTER AND VEHICLE SEAT

(71) Applicant: Adient Engineering and IP GmbH, Burscheid (DE)

(72) Inventor: Ingo QUAST, Duesseldorf (DE)

(21) Appl. No.: 15/864,570

(22) Filed: Jan. 8, 2018

(30) Foreign Application Priority Data
Jan. 9, 2017 (DE) 10 2017 200 176.3
Feb. 16, 2017 (DE) 10 2017 202 518.2

(51) Int. Cl. B60N 2/07; B60N 2/20; F16C 29/04; F16C 33/38

(52) U.S. Cl. CPC B60N 2/0722; B60N 2/20; B60N 2/0715; F16C 2326/08; F16C 33/38; F16C 2208/20; F16C 29/04

(57) ABSTRACT

A longitudinal adjuster (10), for a vehicle seat (1), includes a lower rail (12) and an upper rail (14) which is displaceably guided in a longitudinal direction (x). A bearing element (16) is arranged between the lower rail (12) and the upper rail (14) and is in contact with the lower rail (12) and the upper rail (14). The bearing element (16) has a locking device (20). A displacement of the bearing element (16) relative to the lower rail (12) beyond a predefined action region is prevented during a displacement of the upper rail (14) relative to the lower rail (12) if the locking device (20) interacts with an opening (28) which is arranged in the lower rail (12). This includes a spring section (24) of the locking device (20) pivoting into the opening (28). A vehicle seat (1) is provided having a longitudinal adjuster (10) of this type.

### CROSS REFERENCE TO RELATED APPLICATIONS

This application claims the benefit of priority under 35 U.S.C. § 119 of German Applications 10 2017 200 176.3 and 10 2017 202 518.2, filed on Jan. 9, 2017 and Feb. 16, 2017 (respectively), the entire contents of which are incorporated herein by reference.

### FIELD OF THE INVENTION

The invention relates to a longitudinal adjuster for a vehicle seat, comprising a lower rail and an upper rail which is guided therein such that it can be displaced in the longitudinal direction, and at least one bearing element which is arranged between the lower rail and the upper rail and is in contact with the lower rail and the upper rail, and to a vehicle seat.

### BACKGROUND OF THE INVENTION

DE 10 2011 011 766 A1 has disclosed a longitudinal adjuster of the generic type and a vehicle seat of the generic type. The longitudinal adjuster comprises two rail pairs with in each case two seat rails which can be displaced relative to one another, namely an upper rail and a lower rail which engage around each other mutually. The upper rail can be displaced relative to the lower rail within a comfort adjusting region and, beyond this, into an easy entry position.

Bearing elements are provided between the upper rail and the lower rail, which bearing elements preferably comprise ball cages which consist of plastic and metallic balls which are mounted rotatably therein. Here, the ball cages are arranged in intermediate spaces between the upper rail and the lower rail, the balls being in contact with the upper rail and with the lower rail. In the case of a displacement of the upper rail relative to the lower rail, the balls roll on the upper rail and on the lower rail.

In the case of a displacement of the upper rail relative to the lower rail by a predefined adjusting travel, the bearing elements and therefore also the ball cages theoretically move by half of said adjusting travel.

It occurs in practice, however, that the balls do not roll ideally on the upper rail and on the lower rail, but rather slide or slip along the upper rail and along the lower rail, at least briefly. After a plurality of displacements of the upper rail relative to the lower rail, a movement of the bearing element relative to the upper rail and to the lower rail in comparison with the original position of the bearing element can occur.

In order to avoid the bearing element moving out of the intermediate space between the upper rail and the lower rail, end stops are as a rule provided on the upper rail and on the lower rail, which end stops limit the movement of the bearing element. Here, the introduction of the end stops is comparatively complicated.

### SUMMARY OF THE INVENTION

The invention is based on the problem of improving a longitudinal adjuster of the type mentioned at the outset, in particular of preventing a movement of the bearing element relative to the upper rail and to the lower rail, and of providing a corresponding vehicle seat.

According to the invention, this problem is achieved by way of a longitudinal adjuster for a vehicle seat, comprising a lower rail and an upper rail which is guided therein such that it can be displaced in the longitudinal direction, and at least one bearing element which is arranged between the lower rail and the upper rail and is in contact with the lower rail and the upper rail, the bearing element having a locking means, a displacement of the locking element relative to the lower rail beyond a predefined action region being prevented during a displacement of the upper rail relative to the lower rail if the locking means interacts with an opening which is arranged in the lower rail, in particular by virtue of the fact that a spring section of the locking means has fallen into the opening.

The fact that the bearing element has a locking means, a displacement of the locking element relative to the lower rail beyond a predefined action region being prevented during a displacement of the upper rail relative to the lower rail if the locking means interacts with an opening which is arranged in the lower rail, can ensure that the bearing element is always arranged with optimum loading in the action region and cannot be moved out of the action region. In particular, this provides the possibility that stamping of end stops in the lower rail can be dispensed with, which provides more freedom in the construction and individual configuration of the longitudinal adjuster. The interaction of the locking means and the opening of the lower rail can be brought about, in particular, by virtue of the fact that a spring section of the locking means is configured such that it can be pivoted into the opening by means of a spring force.

The locking means can be held in the bearing element in an integrally joined and/or positively locking manner. The locking means can be manufactured from metal or a plastic. The locking means can be a spring plate. The locking means can be a flat shaped spring. The locking means can be held on the bearing element by means of corresponding holding sections. The locking means can have at least one spring-elastic section, preferably two spring-elastic sections. The preferably two spring-elastic sections can have an offset in the vertical direction. One of the preferably two spring-elastic sections serves to delimit the predefined action region in the longitudinal direction to the front, and the respective other section serves to delimit it in the longitudinal direction to the rear.

The lower rail can preferably have two openings which are assigned to the bearing element. The preferably two openings of the lower rail can have an offset in the vertical direction, in accordance with an offset of the respective cooperating spring-elastic sections. The preferably two openings are preferably spaced apart from one another in the longitudinal direction. The preferably two openings define the action region of the bearing element in the longitudinal direction.

The bearing element is preferably a ball cage which serves as a holding device for a plurality of balls which in turn serve as rolling bodies between the upper rail and the lower rail. As an alternative, the rolling bodies can also be rotational bodies which differ from a spherical shape. The bearing element can be manufactured from a plastic, in particular a polyethylene with a high density (what is known as an HDPE).

Furthermore, the problem, on which the invention is based, is achieved according to the invention by way of a vehicle seat having an above-described longitudinal adjuster.

Before refinements of the invention are described in greater detail in the following text using drawings, it is to be noted first of all that the invention is not restricted to the described components or the described method steps. Furthermore, the terminology which is used is also not of restrictive nature, but rather has merely exemplary character. If the singular is used in the following text in the description and the claims, the plural is included in each case, in so far as the context does not rule this out explicitly.

In the following text, the invention is described in greater detail using one advantageous exemplary embodiment which is shown in the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a diagrammatic illustration of a vehicle seat according to the invention;

FIG. 2 is a perspective illustration of a bearing element according to the invention;

FIG. 3 is a perspective exploded illustration of the bearing element according to the invention from FIG. 2;

FIG. 4 is an enlarged illustration of a detail of a locking means;

FIG. 5 is a sectional illustration in the region of an opening in a lower rail in a first state;

FIG. 6 is a sectional illustration in accordance with FIG. 5 with the locking means in a second state;

FIG. 7 is a sectional illustration in accordance with FIG. 5 with the locking means in a third state;

FIG. 8 is a perspective illustration of the lower rail;

FIG. 9 is a sectional illustration in accordance with FIG. 5 with a mounting aid; and

FIG. 10 is a further sectional illustration in accordance with FIG. 9 with the mounting aid.

### DESCRIPTION OF THE PREFERRED EMBODIMENTS

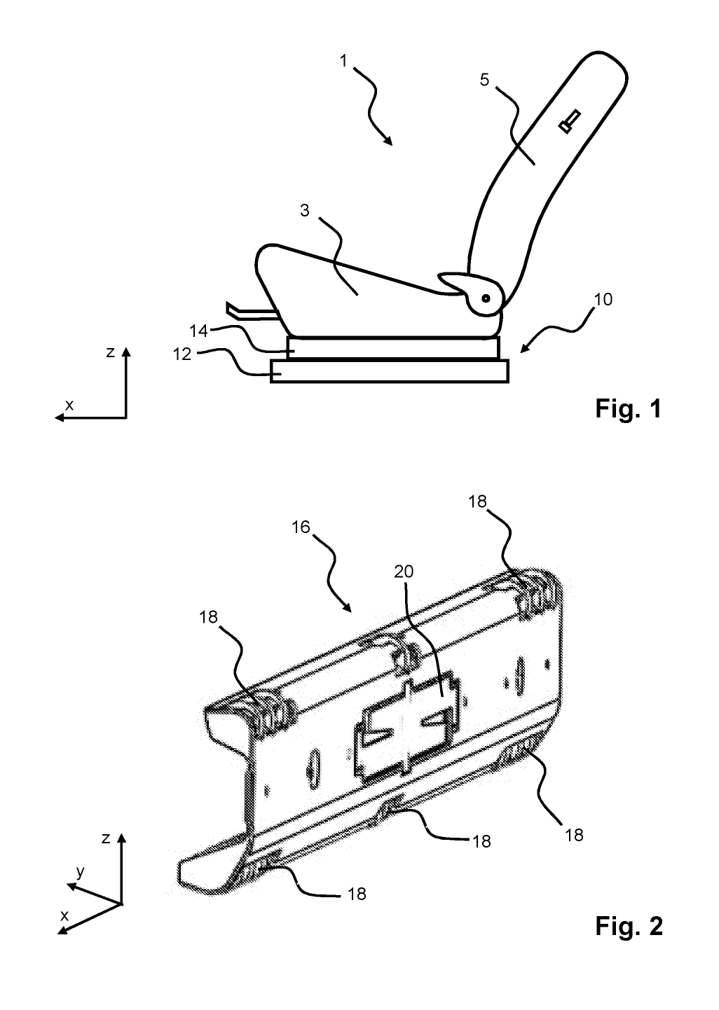

Referring to the drawings, a vehicle seat 1 which is shown diagrammatically in FIG. 1 will be described in the following text with the use of three spatial directions which run perpendicularly with respect to one another. In the case of a vehicle seat 1 which is installed in the vehicle, a longitudinal direction x runs largely horizontally and preferably parallel to a vehicle longitudinal direction which corresponds to the usual driving direction of the vehicle. A transverse direction y which runs perpendicularly with respect to the longitudinal direction x is likewise oriented horizontally in the vehicle and runs parallel to a vehicle transverse direction. A vertical direction z runs perpendicularly with respect to the longitudinal direction x and perpendicularly with respect to the transverse direction y. In the case of a vehicle seat 1 which is installed in the vehicle, the vertical direction z runs parallel to the vehicle vertical axis.

The position specifications and direction specifications which are used, such as front, rear, top and bottom, relate to a viewing direction of an occupant seated in the vehicle seat 1 in a normal seat position, the vehicle seat 1 being installed in the vehicle and being oriented in a use position suitable for passenger transport with an upright backrest 5 and in the driving direction as customary. The vehicle seat 1 can also be installed in a different orientation, however, for example transversely with respect to the driving direction.

The vehicle seat 1 according to the invention has a seat part 3 and the backrest 5, the inclination of which can be adjusted relative to the seat part 3. The vehicle seat 1 is mounted on a longitudinal adjuster 10 according to the invention for adjusting a seat longitudinal position. The longitudinal adjuster 10 comprises a lower rail 12 and an upper rail 14 which is guided therein such that the an upper rail 14 can be displaced in the longitudinal direction x. At least one bearing element 16 is arranged between the lower rail 12 and the upper rail 14, which bearing element 16 is in contact with the lower rail 12 and the upper rail 14.

FIG. 2 shows a perspective illustration of the bearing element 16 according to the invention. The bearing element 16 has a plurality of balls 18 which are mounted in each case rotatably in ball receptacles of the bearing element 16. The bearing element 16 has a locking means 20. A displacement of the bearing element 16 relative to the lower rail 12, during a displacement of the upper rail 14 relative to the lower rail 12, is prevented beyond a predefined action region if the locking means 20 interacts with an opening 28 which is arranged in the lower rail 12. In the present case, the locking means 20 is clipped into a corresponding recess in the bearing element 16. As an alternative or in addition, the locking means 20 can be fixed in the bearing element 16 by way of hot stamping. Furthermore, the locking means 20 can be integrated into the bearing element 16 via a primary forming process. In the present case, the locking means 20 is arranged in the bearing means 16 centrally in the longitudinal direction x. In the present case, the locking means 20 is arranged in the bearing means 16 centrally in the vertical direction z.

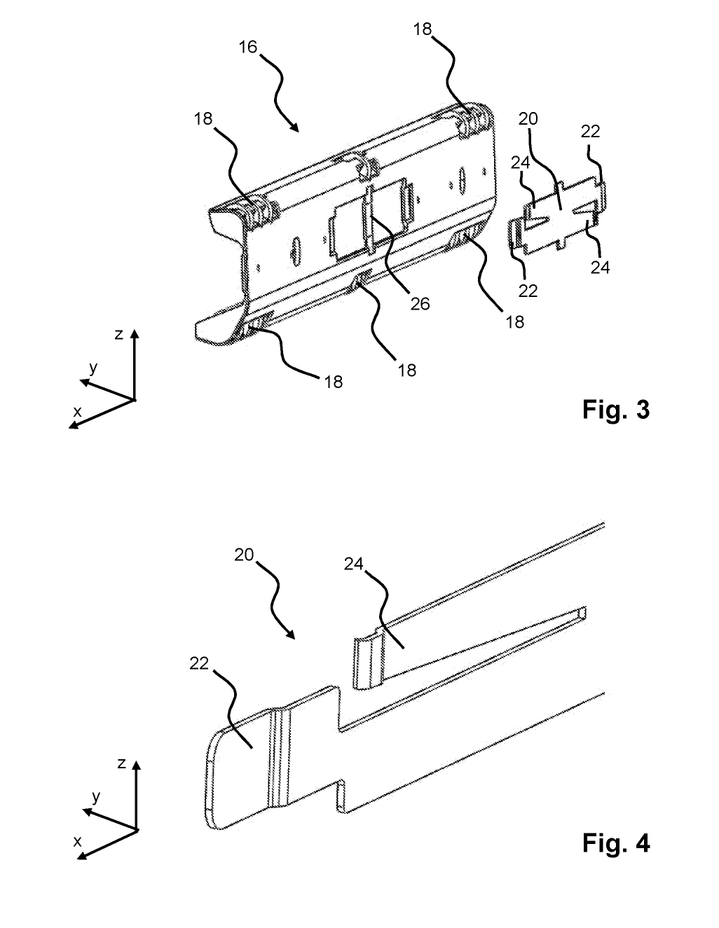

FIG. 3 shows the bearing element 16 from FIG. 2 before mounting of the locking means 20. It is shown here that the bearing element 16 has a bridge 26 in the middle of the recess for receiving the locking means 20. The bridge can serve as a bearing region for the locking element 20 after mounting. Furthermore, stamped portions can be provided in the bearing element 16 in the region of a front and rear (in the longitudinal direction x) end section of the recess, which stamped portions interact with holding sections 22 which are provided on the locking means 20 if the locking means 20 is mounted. The locking means 20 is preferably of symmetrical construction, in particular of rotationally symmetrical construction, relative to a transverse direction y.

FIG. 4 shows an enlarged illustration of a detail of an end of the locking means 20, which end is directed to the front in the longitudinal direction x. The locking means 20 has the holding section 22 at the front end, which holding section 22 serves to fasten the locking means 20 to the bearing element 16. Furthermore, the locking means 20 has an elastic spring section 24 which extends parallel to the longitudinal direction x. In the mounted state, the spring section 24 is guided substantially along an inner side of the lower rail 12.

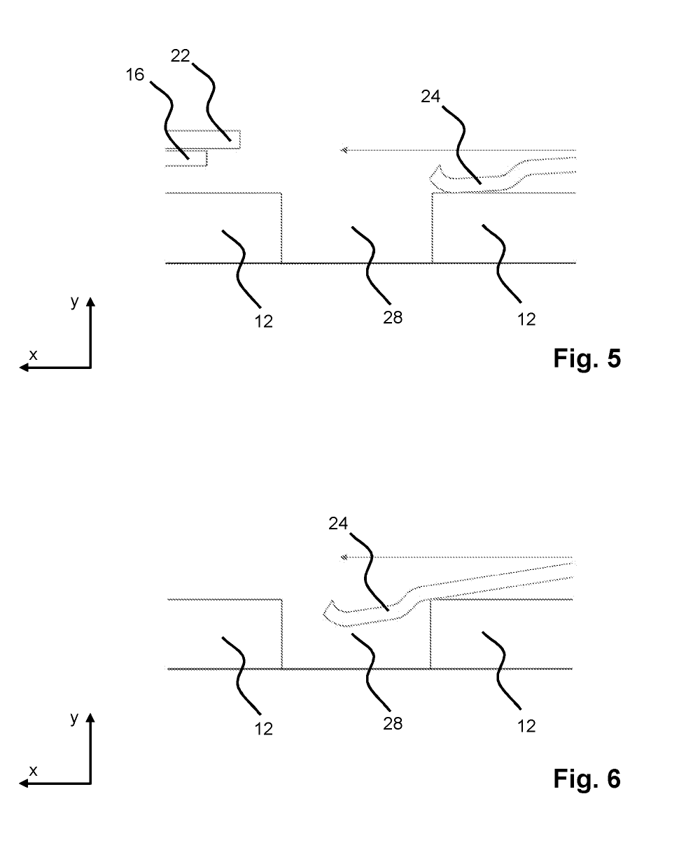

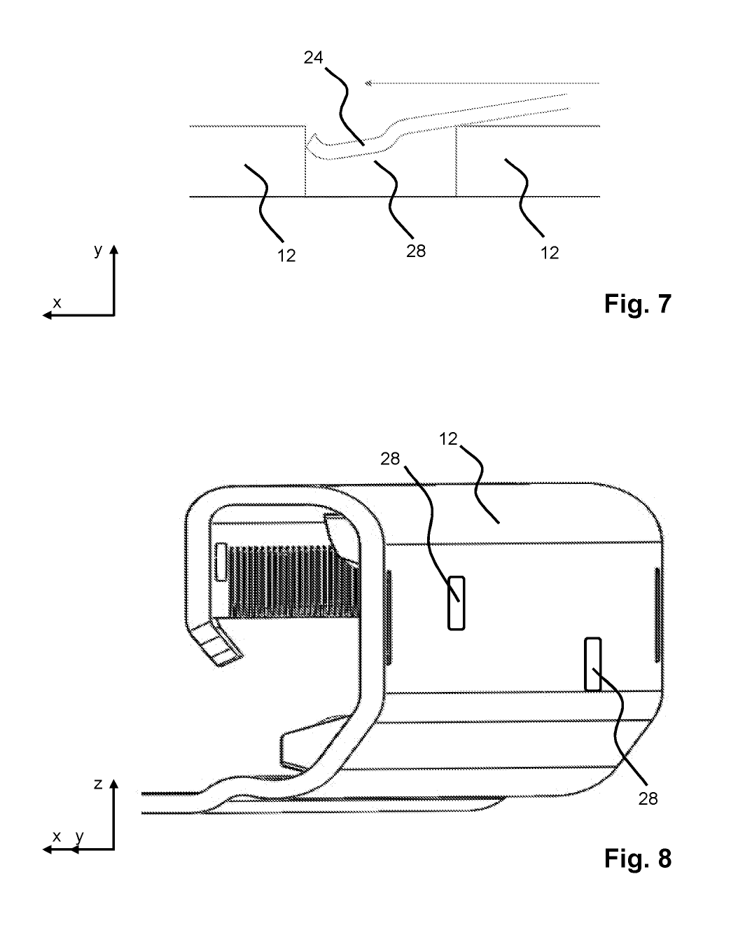

The operating principle of the engagement of the spring section 24 of the locking means 20 into the opening 28 of the lower rail 12 is shown in detail using the sectional illustrations in FIGS. 5 to 7. A movement direction which is assumed via the sequence of FIGS. 5 to 7 is indicated using the illustrated arrow. Here, FIG. 5 shows a state with a movable bearing element 16. In accordance with the state in FIG. 6, the spring section 24 of the locking means 20 has fallen into the opening 28. Finally, FIG. 7 shows a state, in which the free end of the spring section 24 is brought into contact with a front (in the movement direction) edge section of the opening 28, and therefore a further movement of the bearing element 16 in the corresponding direction of movement parallel to the longitudinal direction x of the longitudinal adjuster 10 is locked.

FIG. 8 shows a perspective illustration of the lower rail 12. On its side flank, the lower rail 12 has openings 28 which are positioned individually in accordance with the desired action region or movement region of the bearing element 16. Here, the openings 28 are preferably arranged outside a highly loaded region of the lower rail 12. The two openings 28 are spaced apart in the longitudinal direction x and are arranged with an offset in the vertical direction z. The vertical arrangement of the openings 28 is reversed on that side flank of the lower rail 12 which lies opposite in the transverse direction y. This allows a use of identical parts in the left-hand and right-hand bearing element 16 as viewed in the transverse direction y.

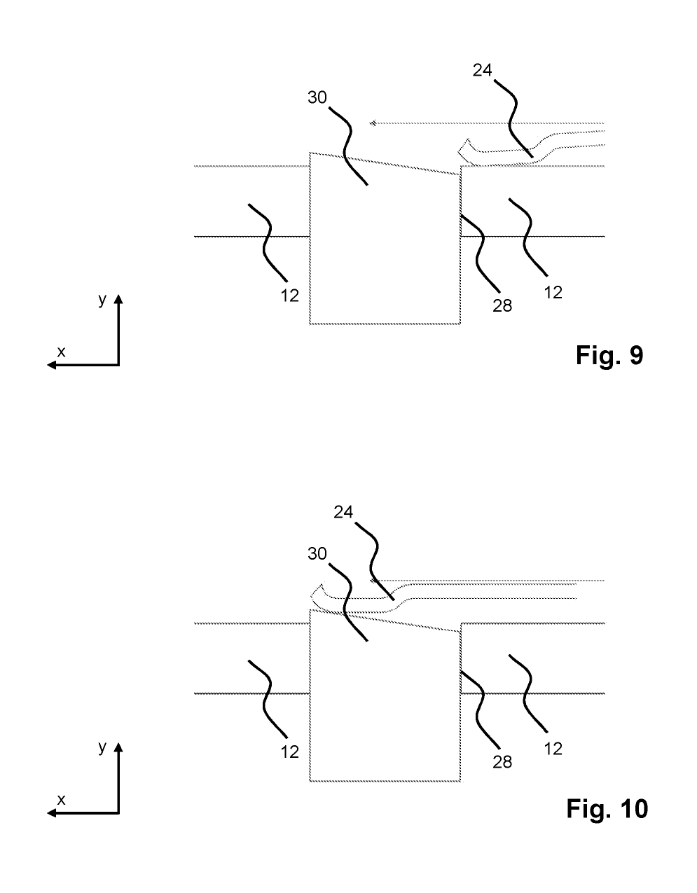

FIGS. 9 and 10 in each case show a sectional illustration in accordance with FIG. 5 with a mounting aid 30 for simpler introduction of the bearing means 16 between the upper rail 14 and the lower rail 12. To this end, the mounting aid 30 is introduced into the openings 28 of the lower rail 12 during the mounting of the longitudinal adjuster 10, in particular during the mounting of the bearing element 16. The mounting aid 30 has a bevelled end face which can be moved over more easily by the spring section 24 in the insertion direction along the illustrated arrow, without the spring section 24 getting caught on the mounting aid 30.

The features which are disclosed in the preceding description, the claims and the drawings can be of significance both individually and in combination for the implementation of the invention in its various refinements.

Although the invention has been described in detail in the drawings and the preceding description, the descriptions are to be understood to be illustrative and exemplary and not restrictive. In particular, the selection of the proportions shown in the drawings of the individual elements is not to be interpreted as required or restrictive. Furthermore, the invention is not restricted to the above-described exemplary embodiments, in particular. Further variants of the invention and their implementation arise for a person skilled in the art from the preceding disclosure, the figures and the claims.

Terms which are used in the claims such as “comprise”, “have”, “contain”, “include” and the like do not rule out further elements or steps. The use of the indefinite article does not rule out a plural. A single device can carry out the functions of a plurality of units or devices mentioned in the claims.

While specific embodiments of the invention have been shown and described in detail to illustrate the application of the principles of the invention, it will be understood that the invention may be embodied otherwise without departing from such principles.

### APPENDIX

### List of Reference Designations

1 Vehicle seat
3 Seat part
5 Backrest
10 Longitudinal adjuster
12 Lower rail
14 Upper rail
16 Bearing element
18 Ball
20 Locking means
22 Holding section
24 Spring section
26 Bridge
28 Opening
30 Mounting aid
x Longitudinal direction
y Transverse direction
z Vertical direction

What is claimed is:

1. A vehicle seat longitudinal adjuster comprising:
a lower rail;
an upper rail;
a bearing element arranged between the lower rail and the upper rail with the bearing element in contact with the lower rail and the upper rail, the upper rail being guided along the upper rail for displacing the upper rail in the longitudinal direction, wherein the bearing element comprises a locking means for preventing a displacement of the bearing element relative to the lower rail beyond a predefined action region during a displacement of the upper rail relative to the lower rail if the locking means interacts with an opening which is arranged in the lower rail and wherein the locking means comprises a spring-elastic section positioned for pivoting into the opening.

2. A vehicle seat longitudinal adjuster according to claim 1, wherein the locking means is integrally joined with the bearing element or is positively locked with the bearing element or is integrally joined with the bearing element and is positively locked with the bearing element to hold the locking means with the bearing element.

3. A vehicle seat longitudinal adjuster according to claim 1, wherein the spring-elastic section of the locking means comprises a spring plate in the form of a flat shaped spring.

4. A vehicle seat longitudinal adjuster according to claim 1, wherein:
the bearing element comprises holding sections; and
the locking means is held on the bearing element by the holding sections.

5. A vehicle seat longitudinal adjuster according to claim 1, wherein the locking means further comprises another spring-elastic section to provide two spring-elastic sections.

6. A vehicle seat longitudinal adjuster according to claim 5, wherein the two spring-elastic sections are offset in a vertical direction.

7. A vehicle seat longitudinal adjuster according to claim 5, one of the two spring-elastic sections delimits the predefined action region in the longitudinal direction to a front and the respective other section of the two spring-elastic sections delimits the predefined action region in the longitudinal direction to a rear.

8. A vehicle seat longitudinal adjuster according to claim 6, wherein another opening is arranged in the lower rail such that the lower rail has two openings offset in the vertical direction in accordance with an offset of the respective cooperating spring-elastic sections.

9. A vehicle seat longitudinal adjuster according to claim 8, wherein the two openings definine the action region of the bearing element in the longitudinal direction.

10. A vehicle seat comprising a vehicle seat longitudinal adjuster comprising:
a lower rail;
an upper rail; and
a bearing element arranged between the lower rail and the upper rail with the bearing element in contact with the lower rail and the upper rail, the upper rail being guided along the upper rail for displacing the upper rail in the longitudinal direction, wherein the bearing element comprises a locking means for preventing a displacement of the bearing element relative to the lower rail beyond a predefined action region during a displacement of the upper rail relative to the lower rail if the locking means interacts with an opening which is arranged in the lower rail and wherein the locking means comprises a spring-elastic section positioned for pivoting into the opening.

11. A vehicle seat according to claim 10, further comprising:
a seat part mounted on the vehicle seat longitudinal adjuster; and
a backrest pivotably connected to the seat part, wherein an inclination the backrest can be adjusted relative to the seat part.

12. A vehicle seat adjuster according to claim 11, wherein the locking means is integrally joined with the bearing element or is positively locked with the bearing element or is integrally joined with the bearing element and is positively locked with the bearing element to hold the locking means with the bearing element

13. A vehicle seat adjuster according to claim 1, wherein the spring-elastic section of the locking means comprises a spring plate.

14. A vehicle seat adjuster according to claim 11, wherein:
the bearing element comprises holding sections; and
the locking means is held on the bearing element by the holding sections.

15. A vehicle seat adjuster according to claim 11, wherein the locking means further comprises another spring-elastic section to provide two spring-elastic sections.

16. A vehicle seat adjuster according to claim 15, wherein the two spring-elastic sections are offset in a vertical direction.

17. A vehicle seat adjuster according to claim 15, one of the two spring-elastic sections delimits the predefined action region in the longitudinal direction to a front and the respective other section of the two spring-elastic sections delimits the predefined action region in the longitudinal direction to a rear.

18. A vehicle seat adjuster according to claim 16, wherein another opening is arranged in the lower rail such that the lower rail has two openings offset in the vertical direction in accordance with an offset of the respective cooperating spring-elastic sections.

19. A vehicle seat adjuster according to claim 18, wherein the two openings definine the action region of the bearing element in the longitudinal direction.
